(19) United States
(12) Patent Application Publication
(10) Pub. No.: US 2026/0369773 A1
(43) Pub. Date: Nov. 19, 2026

(54) BATTERY CUSHIONING MATERIAL AND BATTERY

(71) Applicant: YAMAUCHI CORPORATION, Hirakata-shi, Osaka (JP)

(72) Inventors: Hirokazu YUASA, Hirakata-shi (JP); Tsuyoshi FUJIHARA, Hirakata-shi (JP); Takamitsu OZEKI, Hirakata-shi (JP)

(73) Assignee: Yamauchi Corporation, Hirakata-shi, Osaka (JP)

(21) Appl. No.: 19/126,056

(22) PCT Filed: Nov. 8, 2023
(86) PCT No.: PCT/JP2023/040240

§ 371 Date: Apr. 30, 2025

(30) Foreign Application Priority Data
Nov. 8, 2022 (JP) 2022-178615

(51) Int. Cl. H01M 50/242; H01M 50/293

(52) U.S. Cl. CPC H01M 50/242; H01M 50/293

(57) ABSTRACT

A battery cushioning material includes a composite, and the composite incudes a base made of a fibrous material and a rubber that is impregnated into the base. Pores are present inside the composite. The battery cushioning material is able to stably serving as a cushioning material and storage battery.

### TECHNICAL FIELD

The present invention relates to a battery cushioning material and a battery.

### BACKGROUND ART

Assembled batteries (battery modules), in which electric cells (battery cells) are stacked, are utilized in automobiles, motorcycles, vessels, household fuel cells, and the like. Rechargeable secondary batteries include lithium-ion batteries, which are already widely available, and all-solid-state batteries, which contain no electrolyte and thus do not cause liquid junction between cells, and bipolar nickel-metal hydride cells and lead-acid batteries, which carry a lower risk of abnormal electricity generation than the lithium-ion batteries.

The secondary batteries undergo repeated expansion and contraction during each charge and discharge cycle. Recent improvement in charge capacity and service life increases the extent of expansion/contraction during each charge and discharge cycle and increases the number of repetitions of the expansion/contraction. To make the performance of the batteries stable and increase the service life of the batteries, it is necessary to moderately keep jostling pressure between the stacked electric cells (pressure produced by jostling between the pressure of the expansion of each electric cell and a reaction force to the pressure from another electric cell, hereinafter, simply referred to as “pressure”). For example, during the expansion, it is necessary to avoid applying an excessive pressure to each electric cell, and during the contraction, it is necessary to apply pressure to the extent that each electric cell is moderately fixed/retained.

For example, Patent Document 1 proposes a flameproof sheet including a pair of flameproof materials and an elastic member disposed between the flameproof materials. The cushioning properties of the flameproof sheet are provided by the elastic member made of a rubber sheet or the like. However, the rubber sheet, which is in a flat shape, provides insufficient cushioning properties. This is because the rubber sheet fails to follow the deformation of a battery caused by the expansion/contraction of the battery. Patent Document 2 proposes a rubber sheet in a projection-depression shape as a cushioning material that applies an appropriate pressure between electric cells. FIG. 16 is a perspective view illustrating a conventional battery module cushioning material. As illustrated in FIG. 16, a battery module cushioning material 200 according to Patent Document 1 is a sheet that includes a thick rim 201 on the circumference of the sheet and is made of a rubber formed to be in a projection-depression shape 202.

### LIST OF PRIOR ART DOCUMENTS

### Patent Document

Patent Document 1: JP2022-117936A
Patent Document 2: JP2022-119556A

### SUMMARY OF INVENTION

### Technical Problem

In the case of the rubber sheet disclosed in Patent Document 2, expansion/contraction in a charge and discharge cycle repeatedly causes a projection-depression portion of the rubber sheet to deform. The projection-depression portion of the rubber sheet is increasingly degraded due to the repetitive deformation and heat generated by a battery. In particular, corner portions where projection portions rise from a base portion are subjected to concentrated stress and are thus likely to be cracked. When being cracked, the cushioning properties are degraded to be unable to apply a pressure enough to fix/retain each electric cell in contraction. This problem becomes apparent as the repetitions of the expansion/contraction increase with an increase in the service life of the battery. The degraded cushioning material becomes unable to fulfill its original functions, thus failing to retain each electric cell stably in contraction.

Hence, an objective of the present invention is to provide a battery cushioning material capable of stably serving as a cushioning material, and to provide a battery including the battery cushioning material.

### Solution to Problem

To achieve the objective described above, the present inventors conducted intensive studies and consequently obtained the following findings.

The cushioning material is required to be sufficiently compressed in the expansion of electric cells and to be sufficiently restored in the contraction of the electric cells. It is thus possible to continuously apply an appropriate pressure to the electric cells in the expansion and contraction of the electric cells.

Here, in the case where the compression of the cushioning material needs a large amount of force in the expansion of the electric cells, the cushioning material hinders the expansion of the electric cells, degrading the performance of the battery. For this reason, the cushioning material is required to contract sufficiently even under low pressure. In this regard, a cushioning material including a relatively soft rubber (e.g., a rubber including many pores) or being provided with projections and depressions easily meets this requirement. However, a cushioning material including a rubber sheet easily deforms in a direction (the up-down direction in FIG. 14) perpendicular to a compressive direction (the right-left direction in FIG. 14) when electric cells expand. Thus, it is difficult for the cushioning material to apply an appropriate pressure to the electric cells. In addition, the cushioning material including a soft rubber sheet is easily degraded, and after the repetitive usage, the cushioning material is restored insufficiently in the contraction of electric cells. That is, it is difficult for such a cushioning material to stably serve as a cushioning material.

Hence, the present inventors conducted studies about a cushioning material in which a fibrous material is impregnated with a rubber. That is, the fibrous material includes many pores, thus originally having cushioning properties to some extent. A composite of a fibrous material impregnated with the rubber includes moderate pores and thus easily contracts under low pressure compared with the cushioning material including a rubber sheet (i.e., is excellent in cushioning properties). The presence of the fibrous material enables such a cushioning material to inhibit the deformation of the cushioning material in the direction (the up-down direction in FIG. 14) perpendicular to the compressive direction (the right-left direction in FIG. 14). For this reason, it is possible to apply an appropriate pressure to the electric cells. In addition, the rubber impregnated into the fibrous material can resist being damaged. As a result, the cushioning material is excellent in durability compared with a cushioning material made solely of a rubber. That is, such a cushioning material can stably serve as a cushioning material.

The present inventors have completed the present invention with the above findings.

A battery cushioning material according to an aspect of the present invention is characterized by including a composite, wherein the composite includes a base made of a fibrous material and a rubber impregnated into the base, and pores are present inside the composite.

A battery cushioning material according to an aspect of the present invention is characterized in that the base is a paper, a woven fabric, or a non-woven fabric, and the fibrous material includes one or more materials selected from glass, rock wool, carbon, ceramic, metal, polybenzazole, polyester, and polyamide. In the case where the woven fabric is used, yarns constituting the woven fabric include single yarns, doubled-and-twisted yarns, bulky yarns and the like.

A battery cushioning material according to an aspect of the present invention is characterized in that the pores include discrete cells that are present in the composite in a distributed manner.

A battery cushioning material according to an aspect of the present invention is characterized in that the rubber includes one or more materials selected from fluorocarbon rubber, ethylene propylene copolymer (EPM), ethylene propylene diene copolymer (EPDM), hydrogenated nitrile rubber, silicone rubber, acrylic rubber, ethylene-acrylic rubber, and butyl rubber.

A battery according to an aspect of the present invention is characterized in that the battery cushioning material, in which the above characteristics are combined, is incorporated in the battery.

### Advantageous Effects of Invention

According to the present invention, it is possible to provide a battery cushioning material capable of stably serving as a cushioning material, and to provide a battery including the battery cushioning material.

### BRIEF DESCRIPTION OF DRAWINGS

FIG. 1 is a sectional view of a battery cushioning material according to the present embodiment.

FIG. 2 is a perspective view illustrating an example of a woven fabric having a 3D continuous hollow structure.

FIG. 3 is a diagram illustrating the concept of the woven fabric having the 3D continuous hollow structure.

FIG. 4 is a sectional view of a battery cushioning material according to Application Example 1.

FIG. 5 is a sectional view of a battery cushioning material according to Application Example 2.

FIG. 6 is a sectional view of a battery cushioning material according to Application Example 3.

FIG. 7 is a sectional view of a battery cushioning material according to Application Example 4.

FIG. 8 is a sectional view of a battery cushioning material according to Application Example 5.

FIG. 9 is a perspective view of a battery cushioning material according to Application Example 6.

FIG. 10 is a perspective view of a battery cushioning material according to Application Example 7.

FIG. 11 is a perspective view of a battery cushioning material according to Application Example 8.

FIG. 12 is a perspective view of a battery cushioning material according to Application Example 9.

FIG. 13 is a perspective view of a battery cushioning material according to Application Example 10.

FIG. 14 is a diagram schematically illustrating a lateral side of an assembled battery with pieces of the battery cushioning material according to the present embodiment incorporated therein, during discharge or in a stable state.

FIG. 15 is a diagram schematically illustrating the lateral side of the assembled battery with pieces of the battery cushioning material according to the present embodiment incorporated therein, while its electric cells expand during charge.

FIG. 16 is a perspective view illustrating a conventional battery module cushioning material.

### DESCRIPTION OF EMBODIMENTS

Hereinafter, a battery cushioning material and a battery according to the present embodiment will be described in detail. The battery cushioning material according to the present embodiment is used as a cushioning material surrounding electric cells or is incorporated in an assembled battery (battery module) in which electric cells (battery cells) are stacked, between the electric cells and between a case and the electric cells.

### (battery Cushioning Material)

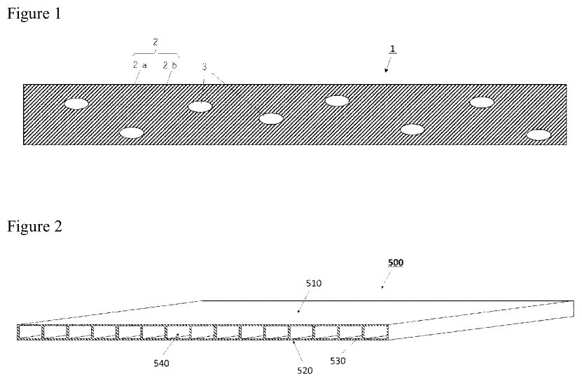

FIG. 1 is a sectional view of the battery cushioning material according to the present embodiment. As illustrated in FIG. 1, a battery cushioning material 1 according to the present embodiment includes a composite 2 of a base 2a made of a fibrous material and a rubber 2b that is impregnated into the base 2a. Inside the composite 2, pores 3 are present. As a result, the battery cushioning material 1 according to the present embodiment is excellent in cushioning properties and durability compared with a cushioning material made solely of a rubber.

There are no constraints on the form of the base 2a as long as the base 2a is made of the fibrous material. Examples of the form of the base 2a include a paper, a woven fabric, and a non-woven fabric. Various forms can be selected for the form of the base 2a in accordance with required specifications, without constraints. For example, although paper is excellent in that it can be obtained inexpensively, it is necessary to laminate a plurality of sheets of paper to obtain high cushioning properties. Note that different types of paper can be used as layers to give different capabilities to the layers. In contrast, a base made of a woven fabric or a non-woven fabric is easily impregnated with the rubber 2b, facilitating providing a thickness to some extent keeping pores or air bubbles, thus bringing such an advantage that the cushioning properties are easily adjustable. In addition, a woven fabric or a non-woven fabric brings such an advantage that it is easily impregnated with a rubber containing a foaming agent.

In particular, a woven fabric brings the advantage of being resistant to deformation and an advantage of being easily formed with the pores. As warp and weft of a woven fabric, a twisted yarn obtained by twisting filaments is used. In the case of a woven fabric including a bulky yarn as the twisted yarn, it is easy to form the pores when the woven fabric is impregnated with the rubber, thus bringing such an advantage that higher cushioning properties are easily obtained.

The woven fabric includes a plain-woven fabric in plain weave, twill weave, imitation gauzes or the like and additionally a woven fabric having a 3D continuous hollow structure.

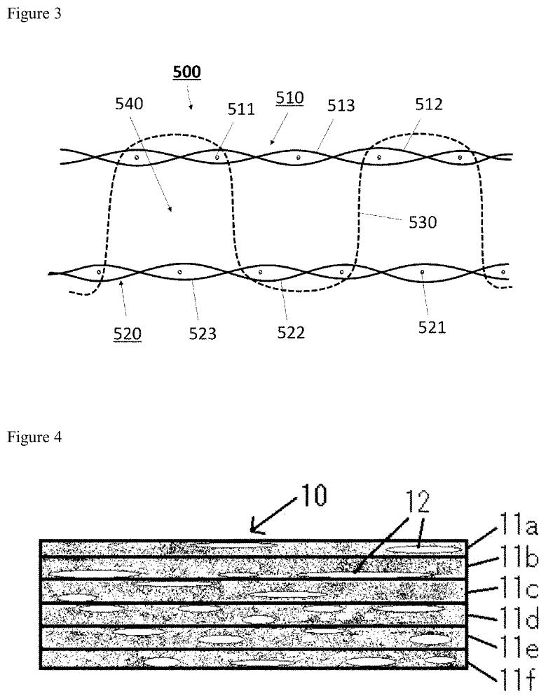

FIG. 2 is a perspective view illustrating an example of a woven fabric having the 3D continuous hollow structure, and FIG. 3 is a diagram illustrating the concept of the woven fabric having the 3D continuous hollow structure. As illustrated in FIG. 2, a woven fabric 500 having the 3D continuous hollow structure is a woven fabric including an upper woven fabric 510 and a lower woven fabric 520 between which hollow portions 540 are formed by vertical yarns (yarns in a thickness direction) 530.

More in detail, as illustrated in FIG. 3, the upper woven fabric 510 is formed by weaving upper warp yarns 511 and upper weft yarns 512 and 513, and the lower woven fabric 520 is formed by weaving lower warp yarns 521 and lower weft yarns 522 and 523. The hollow portions 540 are continuous hollows that are formed by weaving the vertical yarns 530, and the upper warp yarns 511 and the lower warp yarns 521. In the woven fabric 500 having the 3D continuous hollow structure, the thickness (a length in the up-down direction in the figure) and the width (a length in the right-left direction in the figure) of the hollow portions 540 can be changed by changing the method of weaving the vertical yarns 530, and the upper warp yarns 511 and the lower warp yarns 521. As the woven fabric 500 having the 3D continuous hollow structure, PARABEAM 3D from PARABEAM BV (PARABEAM is a registered trademark) can be exemplified.

As the non-woven fabric, for example, a needle-punch non-woven fabric can be exemplified. The needle-punch non-woven fabric brings such an advantage that cushioning properties in its thickness direction are easily obtained due to its fibers being oriented mainly in the thickness direction.

As the fibrous material, various fibrous materials can be selected in accordance with required specifications, without constraints. As the fibrous material, for example, a natural fiber such as a plant fiber or an animal fiber, or a chemical fiber such as a recycled fiber, a synthetic fiber, or an inorganic fiber can be used. More specific examples of the fibrous material include glass, rock wool, carbon, ceramic, metal, polybenzazole, polyester, and polyamide. The base 2a preferably contains one or more types selected from them. In particular, a glass fiber forms a composite with a rubber to produce effects as a fiberglass reinforced rubber (FRR), thus enabling a cushioning material more excellent in heat resistance and durability to be easily provided.

As the material of the rubber 2b, various materials can be selected in accordance with specifications required for the cushioning material (cushioning properties, resilience, heat resistance, durability, etc.), without constraints. Examples of the material of the rubber 2b include fluorocarbon rubber, EPM, EPDM, hydrogenated nitrile rubber, silicone rubber, acrylic rubber, ethylene-acrylic rubber, and butyl rubber. The rubber 2b preferably contains one or more types selected from them.

The pores 3 are present inside the composite 2. For example, the pores 3 may be present in portions into which the rubber 2b is not impregnated, such as gaps between fibers of the base 2a and the peripheries of fibers of the base 2a and may be present inside the rubber 2b. It is preferable that the pores 3 be uniformly distributed.

Note that in the case where an unvulcanized rubber is impregnated into the base 2a and then vulcanized, the pores 3 are usually formed in portions where the rubber 2b is not impregnated. Alternatively, the pores 3 may be formed by the use of, for example, an unvulcanized rubber into which a foaming agent such as thermally expandable microcapsules is kneaded in a distributed manner. In this case, it is possible to distribute the pores 3 more uniformly. In particular, kneading the foaming agent into the unvulcanized rubber well and mixing them uniformly make it easy to apply an appropriate pressure between electric cells.

### Application Example 1

FIG. 4 is a sectional view of a battery cushioning material according to Application Example 1. A battery cushioning material 10 according to Application Example 1 includes composites 11a, 11b, 11c, 11d, 11e, and 11f of bases each made of a paper sheet and a rubber that is impregnated into the bases. Although the base and the rubber are not explicitly illustrated in the figure, most of the part constituting the composites 11a, 11b, 11c, 11d, 11e, and 11f is the base, and the rubber is impregnated into gaps between the fibers of the base. Specifically, the battery cushioning material 10 according to Application Example 1 has a structure in which the composites 11a, 11b, 11c, 11d, 11e, and 11f are laminated. Inside the composites 11a, 11b, 11c, 11d, 11e, and 11f, pores 12 are included.

In each of the paper sheets, fibers are oriented mainly in the planar direction of the paper sheet, thus enabling the thickness of the paper sheet to be reduced. This makes it possible to meet a demand on a battery required to yield savings in space. In addition, the pores formed by impregnating the paper sheets with the rubber take the role of a cushion. Thus, it is possible to provide a battery cushioning material having high cushioning properties. The rubber impregnated into the fibrous material can reduce or eliminate damage to the fibrous material, and its rubber elasticity exhibits a force of restoring the pores. Since the fibers are oriented mainly in the planar direction, it is possible to apply pressure uniformly in a plane and to give cushioning properties uniformly in a plane. Note that the pores are often formed in gaps between fibers or on the peripheries of fibers. The volume of the pores with respect to the volume of the entire composite is calculated as a pore ratio.

For the battery cushioning material, the number of paper sheets, the pore ratio, and the fibrous material can be adjusted/selected in accordance with required cushioning properties, distance between electric cells, heat transfer properties, or the like. The pore ratio can be adjusted with a basis weight of the paper before the impregnation, the amount, the viscosity, the impregnation duration of the rubber to be impregnated or the like. In the battery cushioning material 10 in the present embodiment, six paper sheets that are made of polyamide and impregnated with unvulcanized rubber solution are laminated and integrated together by press cure. The fibrous materials of the paper sheets may be different materials.

Although the above description has shown an example in which the battery cushioning material 10 is composed of multiple layers of composites, the battery cushioning material 10 may be composed of a single layer. One of various numbers of layers can be selected in accordance with required specifications, without constraints. Alternatively, paper sheets not impregnated with the rubber and composites impregnated with the rubber may be alternately laminated. The configurations of the base, the rubber, and the pores are the same as in the example mentioned above.

### Application Example 2

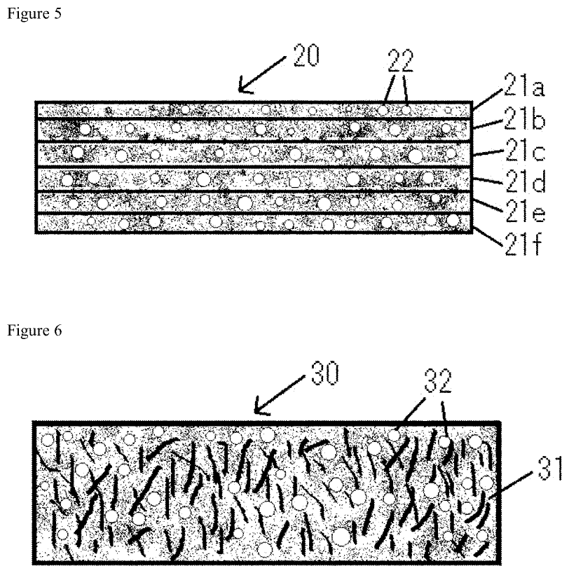

FIG. 5 is a sectional view of a battery cushioning material according to Application Example 2. A battery cushioning material 20 according to Application Example 2 includes composites 21a, 21b, 21c, 21d, 21e, and 21f of bases each made of a paper sheet and a rubber that is impregnated into the bases as with the battery cushioning material according to Application Example 1. Although the base and the rubber are not explicitly illustrated in the figure, most of the part constituting the composites 21a, 21b, 21c, 21d, 21e, and 21f is the base, and the rubber is impregnated into gaps between the fibers of the base. Inside each of the composites 21a, 21b, 21c, 21d, 21e, and 21f, discrete cells 22 are present in a distributed manner.

The discrete cells 22 are closed, substantially spherical pores (independent cavities). The discrete cells 22 are obtained by, for example, impregnating the bases with an unvulcanized rubber into which thermally expandable microcapsules are kneaded in a distributed manner and performing vulcanization. That is, when the rubber is vulcanized, the capsules expand to become the discrete cells that are independently present. The discrete cells 22 are completely enclosed cells, each of which functions as a cushion when the composites are compressed. The pore ratio can be adjusted with the introduction number of the thermally expandable microcapsules to be kneaded into the rubber. The six paper sheets are alternately laminated with five rubber sheets with the thermally expandable microcapsules kneaded therein and are subjected to lamination press at low temperature to be created into an unvulcanized-rubber-impregnated paper sheet. Thereafter, the entire unvulcanized-rubber-impregnated paper sheet is subjected to thermal expansion and vulcanization in a heating furnace to be integrated. Thus, the battery cushioning material 20 can be manufactured.

Unlike the pores in the battery cushioning material according to Application Example 1, it is possible to form the pores in a distributed manner more uniformly because the thermally expandable microcapsules are kneaded in the rubber before the vulcanization in a distributed manner. This enables the battery cushioning material according to Application Example 2 to apply a uniform pressure to electric cells. Although polyamide is used as the fibers constituting the paper sheets in Application Example 1 and Application Example 2, one or more materials selected from glass, rock wool, carbon, ceramic, metal, polybenzazole, polyester, and polyamide may be included.

Although the above description has shown an example in which the paper sheets and the composites are alternately laminated, the battery cushioning material 20 may be composed of a single layer. One of various numbers of layers can be selected in accordance with required specifications, without constraints. The configurations of the base, the rubber, and the pores are the same as in the example mentioned above.

### Application Example 3

FIG. 6 is a sectional view of a battery cushioning material according to Application Example 3. A battery cushioning material 30 according to Application Example 3 includes a composite of a base that is made of a non-woven fabric and a rubber that is impregnated into the base. Although the base and the rubber are not explicitly illustrated in the figure, most of the part constituting the composite is the base, and the rubber is impregnated into gaps between the fibers of the base. The composite includes pores 32 inside the composite. The pores 32 are formed in gaps between fibers of the non-woven fabric and the peripheries of fibers of the non-woven fabric.

In the non-woven fabric, its fibers are oriented in not only its in-plane direction but also its thickness direction. Thus, the non-woven fabric has such characteristics of being high in cushioning properties and resilience compared with a paper sheet, in which its fibers are oriented mainly in its in-plane direction.

As the non-woven fabric, it is particularly preferable to use a needle-punch non-woven fabric. In a needle-punch non-woven fabric has higher cushioning properties and resilience due to its fibers oriented mainly in its thickness direction. The configurations of the base, the rubber, and the pores are the same as in the example mentioned above.

### Application Example 4

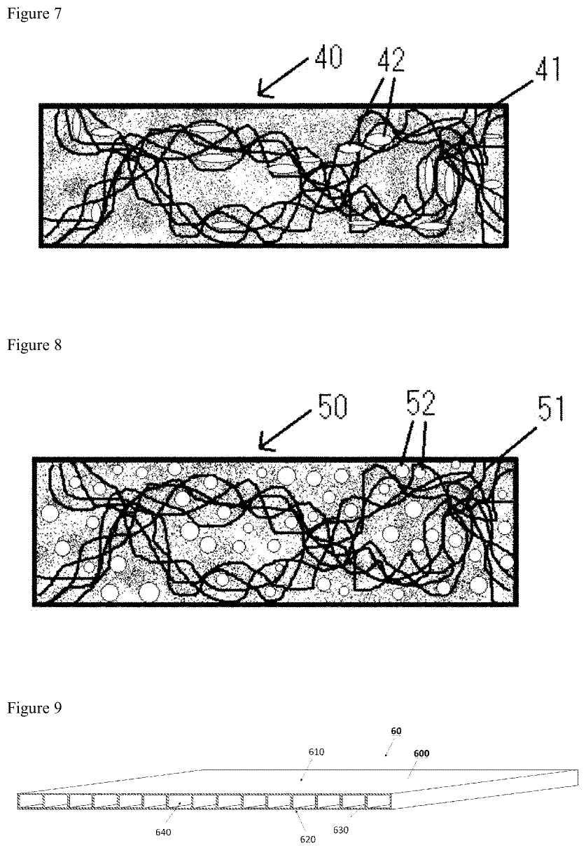

FIG. 7 is a sectional view of a battery cushioning material according to Application Example 4. A battery cushioning material 40 according to Application Example 4 includes a composite of a base that is made of a woven fabric of glass-fiber bulky yarns 41 and a rubber that is impregnated into the base. Although the base and the rubber are not explicitly illustrated in the figure, most of the part constituting the composite is the base, and the rubber is impregnated into gaps between the fibers of the base. The composite includes pores 42 inside the composite. The pores 42 are formed in gaps between the bulky yarns and the peripheries of the bulky yarns.

### Application Example 5

FIG. 8 is a sectional view of a battery cushioning material according to Application Example 5. A battery cushioning material 50 according to Application Example 5 includes a composite of a base that is made of a woven fabric of glass-fiber bulky yarns 51 and a rubber that is impregnated into the base, as with the battery cushioning material according to Application Example 4. Although the base and the rubber are not explicitly illustrated in the figure, most of the part constituting the composite 50 is the base, and the rubber is impregnated into gaps between the fibers of the base. Inside the composite, discrete cells 52 are present in a distributed manner.

The woven fabric made of the glass-fiber bulky yarns 51 offers heat resistance, its bulkiness offers cushioning properties, and the impregnated rubber offers excellent durability. Furthermore, the discrete cells 52 present in a distributed manner increase the cushioning properties. The cushioning properties of the battery cushioning material 50 are increased by, in addition to the cushioning properties and the heat resistance offered by the bulky yarns 51 made of glass fibers, the size and the number of the discrete cells 52, that is, the ratio of the volume of the discrete cells 52 to the volume of the entire composite, and pores provided by the discrete cells 52. The pore ratio can be adjusted with the introduction number of the thermally expandable microcapsules to be kneaded into the rubber. In order to apply an appropriate pressure between electric cells, it is preferable that the thermally expandable microcapsules be kneaded uniformly, and thus the thermally expandable microcapsules need to be kneaded into the rubber well.

In Application Examples 1 to 5, in the case where heat insulation is required, for example, between electric cells in an assembled battery and between the battery and a case, it is preferable to use a fiber having high heat resistance and a rubber having high heat insulation properties. For example, it is preferable to use a glass fiber, which has high heat resistance, and fluorocarbon rubber or silicone rubber, which has low thermal conductivity. In this case, it is possible to restrain thermal conduction to neighboring cells, thus restraining the thermal runaway of the cells.

### Application Example 6

FIG. 9 is a perspective view of a battery cushioning material according to Application Example 6. A battery cushioning material 60 according to Application Example 6 includes a composite 600 of a base that is made of a woven fabric having a 3D continuous hollow structure and a rubber that is impregnated into the base. The composite 600 includes an upper woven fabric 610 impregnated with a rubber, a lower woven fabric 620 impregnated with a rubber, and vertical yarns 630 impregnated with a rubber. The composite 600 further includes hollow portions 640. Although the base and the rubber are not explicitly illustrated in the figure, in the composite 600, the rubber is impregnated into the fibers of the upper woven fabric 610, the lower woven fabric 620, and the vertical yarns 630 and into gaps between the fibers. In the battery cushioning material 60 according to Application Example 6, the hollow portions 640 function as pores.

Including the hollow portions 640, the battery cushioning material 60 according to Application Example 6 brings such an advantage that high cushioning properties are obtained in spite of lightness in weight compared with a conventional cushioning material made of a plain-woven fabric. In particular, the battery cushioning material 60 is useful in the application that particularly requires lightness in weight, such as a drone or an unmanned aerial vehicle. In addition, the hollow portions 640 are continuous hollows, through which fluid such as air easily flows, thus bringing such an advantage that the battery cushioning material 60 has high heat dissipation properties. The cushioning properties, the heat dissipation properties, and the like of the battery cushioning material 60 according to Application Example 6 can be adjusted by adjusting the thicknesses of the upper woven fabric 610 and the lower woven fabric 620, the lengths of the vertical yarns 630, the amount of the rubber to be impregnated, or the like. As the fibrous materials of the upper woven fabric, the lower woven fabric, and the vertical yarns, glass, rock wool, carbon, ceramic, metal, poly benzazole, polyester, and polyamide can be used.

### Application Examples 7 to 10

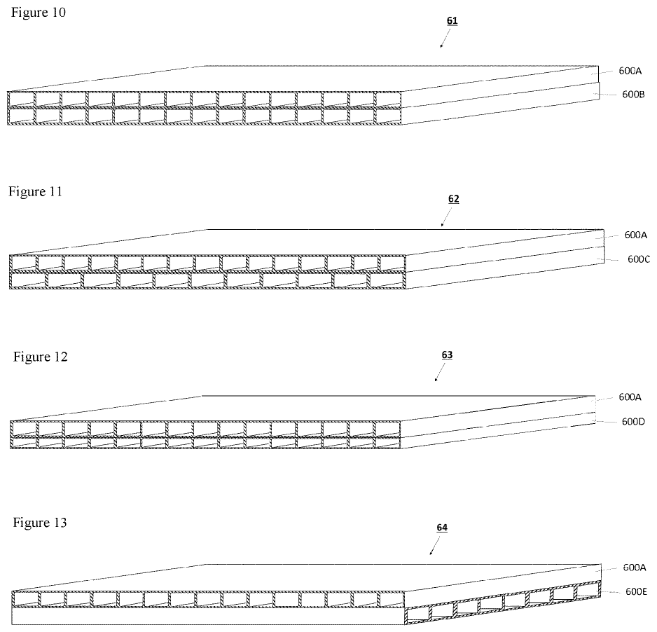

FIG. 10 is a perspective view of a battery cushioning material according to Application Example 7. A battery cushioning material 61 according to Application Example 7 includes two layers of composites 600A and 600B each having the same configuration as in Application Example 6. The two layers of composites 600A and 600B are bonded together with an adhesive or the like. The battery cushioning material 61 according to Application Example 7 brings such an advantage that, for example, higher cushioning properties are easily obtained compared with the composite 600, which is a single layer. Thus, the battery cushioning material 61 can be adopted in accordance with the usage of the cushioning material.

Note that the cushioning properties of a cushioning material including a woven fabric having the 3D continuous hollow structure as its base are caused to exert mainly by the buckling of vertical yarns impregnated with a rubber, and bending in opposite directions of joint portions between the vertical yarns and an upper woven fabric and joint portions between the vertical yarns impregnated with the rubber and a lower woven fabric (e.g., when pressure is applied to upper and lower surfaces, the upper woven fabric moves in a given direction (e.g., the right direction in FIG. 9), while the lower woven fabric moves in the opposite direction of the upper woven fabric (e.g., the left direction in FIG. 9)). This causes a positional shift between the upper surface and the lower surface when the pressure is applied to the upper and lower surfaces. For this reason, the two layers of the composites 600A and 600B are preferably bonded together such that the moving direction of a lower woven fabric of the composite 600A as the first layer matches the moving direction of an upper woven fabric of the composite 600B as the second layer when the pressure is applied to the upper and lower surfaces.

FIG. 11 is a perspective view of a battery cushioning material according to Application Example 8. A battery cushioning material 62 according to Application Example 8 includes, as in Application Example 7, two layers of composites 600A and 600C, where the width of the hollow portions of the composite 600C is made different from the width of the hollow portions of the composite 600A. The battery cushioning material 62 according to Application Example 8 brings such an advantage that the battery cushioning material 62 can be made to differ in cushioning properties between its front and back sides, compared with the battery cushioning material 61 according to Application Example 7, which includes the two layers of the composites having the same structure. In addition, by making the battery cushioning material 62 include two or more layers, it is possible to give the entire battery cushioning material a flexible retention force for pressure caused by the expansion of a battery. That is, it is possible for the battery cushioning material 62 to contract under low pressure in an initial stage of expansion and to retain electric cells with a constant pressure in an expansion to a certain degree. For this reason, the battery cushioning material 62 can be adopted in accordance with the usage of the cushioning material.

FIG. 12 is a perspective view of a battery cushioning material according to Application Example 9. A battery cushioning material 63 according to Application Example 9 includes, as in Application Example 7, two layers of composites 600A and 600D, where the thickness of the hollow portions of the composite 600D (the lengths of vertical yarns) is made different from the thickness of the hollow portions of the composite 600A. The battery cushioning material 63 according to Application Example 9 brings such an advantage that the battery cushioning material 63 can be made to differ in cushioning properties between its front and back sides, compared with the battery cushioning material 61 according to Application Example 7, which includes the two layers of the composites having the same structure. In addition, two or more layers with different thicknesses of hollow portions (the lengths of vertical yarns) make it possible to give the entire battery cushioning material a flexible retention force for pressure caused by the expansion of a battery. That is, it is possible for the battery cushioning material 63 to contract under low pressure in an initial stage of expansion and to retain electric cells with a constant pressure in an expansion to a certain degree. For example, the battery cushioning material 63 is configured such that a layer having high cushioning properties, that is, including hollow portions with a large thickness is provided on a surface to be in contact with a battery, and such that a layer having low cushioning properties, that is, including hollow portions with a small thickness compared with the layer on the surface to be in contact with the battery is provided on a surface to be in contact with no battery. Alternatively, the battery cushioning material 63 may be reversely configured. For this reason, the battery cushioning material 63 can be adopted in accordance with the usage of the cushioning material.

FIG. 13 is a perspective view of a battery cushioning material according to Application Example 10. A battery cushioning material 64 according to Application Example 10 includes, as in Application Example 7, two layers of composites 600A and 600E, where the orientation of the hollow portions of the composite 600C is made different from the orientation of the hollow portions of the composite 600A. The battery cushioning material 64 according to Application Example 10 can change the moving directions of the upper and lower surfaces of each layer when pressure is applied to its upper and lower surfaces, compared with the battery cushioning material 61 according to Application Example 7, which includes the two layers of the composites having the same structure. For this reason, the battery cushioning material 64 can be adopted in accordance with the usage of the cushioning material.

### Other Application Examples

As the battery cushioning material, for example, a battery cushioning material that is the battery cushioning material 60 according to Application Example 6 in which a portion of the composite 600 is changed to the composite 600C, 600D, or 600E, which have the other configurations, can be used. For example, the cushioning material in which a portion of the composite 600 is removed and replaced with the composite 600C, 600D, or 600E may be used. In addition, the cushioning material in which a portion of the composite 600 is changed to the composite 600C, 600D, or 600E, which have the other configurations, may be used as a portion of multiple layers of composites. An example of this is a cushioning material that is the battery cushioning material 61 according to Application Example 7 in which a portion of the composite 600B as the second layer is removed and replaced with the composite 600C, 600D, or 600E. Such a cushioning material is useful in the case where it is intended to change the capabilities (the cushioning properties, the heat dissipation properties, etc.) of a portion of the cushioning material.

### Battery

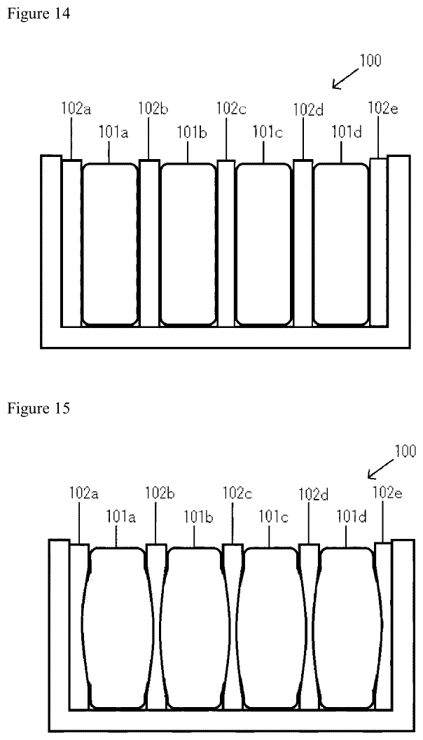

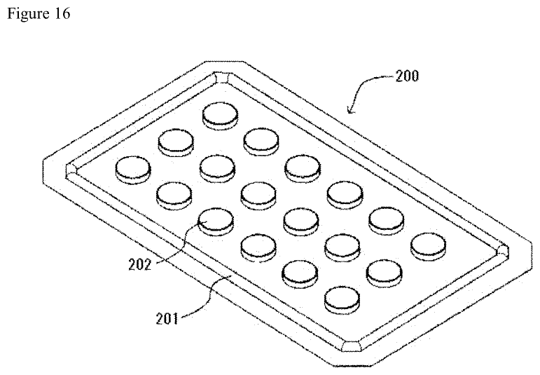

FIG. 14 is a diagram schematically illustrating a lateral side of an assembled battery with pieces of the battery cushioning material according to the present embodiment incorporated therein, during discharge or in a stable state. FIG. 15 is a diagram schematically illustrating the lateral side of the assembled battery with pieces of the battery cushioning material according to the present embodiment incorporated therein, while its electric cells expand during charge.

An assembled battery 100 according to the present embodiment includes a plurality of electric cells 101a, 101b, 101c, and 101d and a plurality of pieces of battery cushioning material 102a, 102b, 102c, 102d, and 102e that are disposed side by side in a case. As the pieces of the cushioning material to be incorporated between the electric cells, the cushioning materials according to Application Example 1 to Application Example 5 or a form obtained by freely combining the cushioning materials without departing the gist of the present invention can be adopted.

The assembled battery 100 combined with the pieces of cushioning material 102a, 102b, 102c, 102d, and 102e undergoes repeated expansion and contraction during each charge and discharge cycle. Here, a cushioning material including a rubber sheet or a sponge rubber sheet as in related art easily deforms in a direction (the up-down direction in FIG. 14) perpendicular to a compressive direction (the right-left direction in FIG. 14) when electric cells expand. Thus, it is difficult for the cushioning material to apply an appropriate pressure to the electric cells. In contrast, the cushioning material used in the assembled battery 100 according to the present embodiment, which includes the base, can inhibit the deformation of the composite material in the direction (the up-down direction in FIG. 14) perpendicular to the compressive direction (the right-left direction in FIG. 14). For this reason, it is possible to apply an appropriate pressure to the electric cells.

In addition, the assembled battery according to the present embodiment includes the cushioning material that exhibits such cushioning properties that retain each electric cell with an appropriate reaction force over the entire lateral side of the battery in contraction. Thus, the assembled battery is excellent in battery characteristics. Although the above has mainly described the assembled battery with the battery cushioning material according to the present embodiment incorporated therein as an example, the battery cushioning material according to the present embodiment can be used as, for example, a case of an electric cell or a cushioning material used between an electric cell and a case.

Part or all of the embodiment mentioned above can be expressed as, but not limited to, the following supplements.

(Supplement 1) A battery cushioning material including a composite, wherein the composite includes a base made of a fibrous material and a rubber impregnated into the base, and pores are present inside the composite.

(Supplement 2) The battery cushioning material according to Supplement 1, wherein
the base is a paper, a woven fabric, or a non-woven fabric, and
the fibrous material includes one or more materials selected from glass, rock wool, carbon, ceramic, metal, polybenzazole, polyester, and polyamide.

(Supplement 3) The battery cushioning material according to Supplement 1 or 2, wherein
the pores include discrete cells that are present in the composite in a distributed manner.

(Supplement 4) The battery cushioning material according to any one of Supplements 1 to 3, wherein
the rubber includes one or more materials selected from fluorocarbon rubber, EPM, EPDM, hydrogenated nitrile rubber, silicone rubber, acrylic rubber, ethylene-acrylic rubber, and butyl rubber.

(Supplement 5) A battery using the battery cushioning material according to any one of Supplements 1 to 4.

(Supplement 6) A method for manufacturing the battery cushioning material according to any one of Supplements 1 to 4, the method including
performing, after impregnating the base with an unvulcanized rubber,
vulcanization by pressurizing and heating the base impregnated with the unvulcanized rubber.

(Supplement 7) The method for manufacturing the battery cushioning material according to Supplement 6, wherein the unvulcanized rubber includes thermally expandable microcapsules.

(Supplement 8) The method for manufacturing the battery cushioning material according to Supplement 6 or 7, including
performing vulcanization by pressurizing and heating bases impregnated with
the unvulcanized rubber in a state where the bases are laminated.

(Supplement 9) A battery cushioning material including
a composite of a base made of a paper and a rubber impregnated into the base, wherein pores are present inside the composite.

(Supplement 10) The battery cushioning material according to Supplement 9, wherein
a plurality of composites is laminated, the plurality of composites each being the composite.

(Supplement 11) The battery cushioning material according to Supplement 10, wherein
at least one of the composites and at least one sheet of paper are alternately laminated.

(Supplement 12) A battery including the battery cushioning material according to any one of Supplements 9 to 11.

(Supplement 13) A method for manufacturing the battery cushioning material according to any one of Supplements 9 to 12, the method including
performing, after impregnating the base with an unvulcanized rubber,
vulcanization by pressurizing and heating the base impregnated with the unvulcanized rubber.

(Supplement 14) The method for manufacturing the battery cushioning material according to Supplement 13, wherein
the unvulcanized rubber includes thermally expandable microcapsules.

(Supplement 15) The method for manufacturing the battery cushioning material according to Supplement 13 or 14, including
performing vulcanization by pressurizing and heating bases impregnated with the unvulcanized rubber in a state where the bases are laminated.

(Supplement 16) A battery cushioning material including
a composite of a base made of a woven fabric and a rubber impregnated into the base, wherein pores are present inside the composite.

(Supplement 17) The battery cushioning material according to Supplement 16, wherein
the woven fabric is a woven fabric including glass-fiber bulky yarns.

(Supplement 18) A battery including the battery cushioning material according to Supplement 16 or 17.

(Supplement 19) A method for manufacturing the battery cushioning material according to Supplement 16 or 17, the method including
performing, after impregnating the base with an unvulcanized rubber,
vulcanization by pressurizing and heating the base impregnated with the unvulcanized rubber.

(Supplement 20) The method for manufacturing the battery cushioning material according to Supplement 19, wherein
the unvulcanized rubber includes thermally expandable microcapsules.

(Supplement 21) The method for manufacturing the battery cushioning material according to Supplement 19 or 20, including
performing vulcanization by pressurizing and heating bases impregnated with the unvulcanized rubber in a state where the bases are laminated.

(Supplement 22) A battery cushioning material including
a composite of a base made of a non-woven fabric and a rubber impregnated into the base, wherein pores are present inside the composite.

(Supplement 23) The battery cushioning material according to Supplement 22, wherein the non-woven fabric is a needle-punch non-woven fabric.

(Supplement 24) A battery including the battery cushioning material according to Supplement 22 or 23.

(Supplement 25) A method for manufacturing the battery cushioning material according to Supplement 22 or 23, the method including
performing, after impregnating the base with an unvulcanized rubber,
vulcanization by pressurizing and heating the base impregnated with the unvulcanized rubber.

(Supplement 26) The method for manufacturing the battery cushioning material according to Supplement 25, wherein
the unvulcanized rubber includes thermally expandable microcapsules.

(Supplement 27) The method for manufacturing the battery cushioning material according to Supplement 25 or 26, including performing vulcanization by pressurizing and heating bases impregnated with the unvulcanized rubber in a state where the bases are laminated.

(Supplement 28) A battery cushioning material including
a composite of a base and a rubber impregnated into the base, the base being made of a woven fabric including an upper woven fabric, a lower woven fabric, and a hollow portion that is formed between the upper woven fabric and the lower woven fabric with vertical yarns (yarns in a thickness direction), the woven fabric having a 3D continuous hollow structure.

(Supplement 29) The battery cushioning material according to Supplement 28, wherein
the hollow portion is a continuous pore.

(Supplement 30) A battery including the battery cushioning material according to Supplement 28 or 29.

(Supplement 31) A method for manufacturing the battery cushioning material according to Supplement 28 or 29, the method including
performing, after impregnating the base with an unvulcanized rubber,
vulcanization by pressurizing and heating the base impregnated with the unvulcanized rubber.

### INDUSTRIAL APPLICABILITY

The battery cushioning material and the battery according to the present invention is effectively used for secondary batteries, which have been increasing in capacity and service life. Examples of the application of secondary batteries include electricity/information/communication application (e.g. mobile phones, smartphones, laptops, digital cameras, activity trackers, ARM computers, electronic papers, card electronic money, smartwatches, etc.) household/small-scale industry application (e.g., power tools, golf carts, household/nursing-care/industrial robots, etc.), large-scale industry application (e.g., forklifts, elevators, gantry cranes, etc.), transportation system application (e.g., hybrid vehicles, electric vehicles, buses, electric trains, vessels, power-assisted bicycles, electric two wheelers, drones, etc.), electric power system application (e.g., various power generators, load conditioners, smart grids, household power storage systems, etc.), medical application (earphone-type hearing aids, etc.), and pharmaceutical application (dosage management systems, etc.), IoT application, space/deep sea application (e.g., space probes, research submersibles, etc.).

### REFERENCE SIGNS LIST

1, 10, 20, 30, 40, 50 battery cushioning material
2 composite
2a base
2b rubber
11a, 11b, 11c, 11d, 11e, 11f composite
12, 42 pore
22, 32, 52 discrete cell
100 assembled battery (battery)
101a, 101b, 101c, 101d electric cell
102a, 102b, 102c, 102d, 102e battery cushioning material
200 battery module cushioning material
201 rim
202 projection-depression shape
500 woven fabric of 3D continuous hollow structure
510 upper woven fabric
520 lower woven fabric
530 vertical yarn
540 hollow portion
511 upper warp yarn
512, 513 upper weft yarn
521 lower warp yarn
522, 523 lower weft yarn
60, 61, 62, 63, 64 battery cushioning material
600, 600A, 600B, 600C, 600D, 600E composite
610 upper woven fabric impregnated with rubber
620 lower woven fabric impregnated with rubber
630 vertical yarn impregnated with rubber
640 hollow portion

1. A battery cushioning material including a composite, wherein
the composite includes a base made of a fibrous material and a rubber impregnated into the base; and
pores are present inside the composite.

2. The battery cushioning material according to claim 1, wherein
the base is a paper, a woven fabric, or a non-woven fabric, and
the fibrous material includes one or more materials selected from glass, rock wool, carbon, ceramic, metal, polybenzazole, polyester, and polyamide.

3. The battery cushioning material according to claim 1 wherein
the pores include discrete cells that are present in the composite in a distributed manner.

4. The battery cushioning material according claim 1, wherein
the rubber includes one or more materials selected from fluorocarbon rubber, ethylene propylene copolymer (EPM), ethylene propylene diene copolymer (EPDM), hydrogenated nitrile rubber, silicone rubber, acrylic rubber, ethylene-acrylic rubber, and butyl rubber.

5. A battery using the battery cushion material according to claim 1.

6. A battery using the battery cushion material according to claim 2.

7. A battery using the battery cushion material according to claim 3.

8. A battery using the battery cushion material according to claim 4.
